(19) United States
(12) Patent Application Publication
(10) Pub. No.: US 2015/0365768 A1
(43) Pub. Date: Dec. 17, 2015

(54) MOTOR FOR DYNAMIC LOUDSPEAKER

(71) Applicant: SHANDONG GETTOP ACOUSTIC CO., LTD, Weifang, Shandong (CN)

(72) Inventors: Morten Kjeldsen ANDERSEN, Odder (DK); Preben KVIST, Kobenhavn (DK); Kurt SORENSEN, Juelsminde (DK)

(21) Appl. No.: 14/357,747

(22) PCT Filed: Apr. 8, 2013
(86) PCT No.: PCT/CN2013/073850

§ 371 Date: May 12, 2014

(30) Foreign Application Priority Data
Mar. 8, 2013 (CN) 201310073091.7

(51) Int. Cl. H04R 9/02; H04R 9/06

(52) U.S. Cl. CPC H04R 9/025; H04R 9/06

(57) ABSTRACT

A motor for a dynamic loudspeaker includes a pole plate; a plurality of magnets positioned on the pole plate having a plurality of outer magnets and an inner magnet. The motor further includes a plurality of magnet poles positioned on the magnets. The magnet poles include a plurality of outer magnet poles and an inner magnet pole. A coil is positioned in the air gap formed between the outer magnets and the inner magnet as well as between the outer magnet poles and the inner magnet pole. The coil has a concave shape formed by recessing a part of its circumference in a plane view.

### CROSS-REFERENCE TO RELATED APPLICATIONS

This application is the national phase of International Application No. PCT/CN2013/073850 filed on Apr. 8, 2013, and related to and claims the benefit of Chinese Patent Application No. 201310073091.7, filed on Mar. 8, 2013, the entire contents of which are herein incorporated by reference.

### TECHNICAL FIELD

The present disclosure relates to a speaker, and in particular, to a motor for driving a dynamic loudspeaker.

### BACKGROUND

A loudspeaker is a device for projecting sound waves, in which a dynamic loudspeaker is the most commonly used.

A dynamic loudspeaker generally consists of three systems: a vibrating system, comprising a conical or flat diaphragm, centering disc, etc.; a motor comprising permanent magnet, conductive magnet plate, center post, coil etc.; and an auxiliary system, comprising a flexible suspension, wiring board, front cover, etc.

The dynamic loudspeaker uses a lightweight diaphragm, or cone, connected to a rigid basket, or frame, via a flexible suspension, that constrains a coil of fine tinsel wire to move axially through a cylindrical magnetic gap. When an electrical signal is applied to the voice coil, a magnetic field is created by the electric current in the voice coil, making it a variable electromagnet. The coil and the driver's magnetic system interact, generating a mechanical force that causes the coil (and thus, the attached cone) to move back and forth, thereby reproducing sound under the control of the applied electrical signal coming from the amplifier.

A method of increasing the output of the dynamic loudspeaker is to increase the working current, which is generally done by reducing the impedance of the coil in conventional loudspeakers or increase the amplifier power.

However, it has the disadvantages of heating up the coil leading to a huge challenge in handling the increased temperature (over 150° Celsius) in the coil and other parts in close contact to the coil.

Therefore, there is a need for a motor for use in a dynamic loudspeaker that can significantly increase the sensitivity and output of the loudspeaker while not heating up the coil and other parts in close contact with the coil.

### SUMMARY

In view of the above need, the present inventor made extensive investigations by hard work, and unexpectedly found a good way for addressing the aforementioned problem, which finally leads to the present disclosure.

Correspondingly, one object of the present disclosure is to provide a motor for a dynamic loudspeaker, which can increase the sensitivity of the loudspeaker without increasing the power level of the dynamic loudspeaker.

Aspects of the disclosure are described below.

A first aspect of the disclosure is a motor for a dynamic loudspeaker that comprises pole plate; magnets positioned on the pole plate, comprising outer magnets and an inner magnet; magnet poles positioned on the magnets, comprising outer poles and an inner pole; and coil positioned in the air gap formed between the outer magnets and the inner magnet as well as between the outer magnet poles and inner magnet pole, wherein the coil has a concave shape formed by recessing a part of its circumference in a plane view.

In the first aspect, the concave shape may be H shape or S shape.

In the first aspect, the concave shape may be irregular shape with a part of its circumference being recessed.

In the first aspect, the air gap formed between the outer magnet and the inner magnet may be H shape, S shape or any other concave shape.

In the first aspect, the air gap formed between the outer magnet pole and the inner magnet pole may be H shape, S shape or any other concave shape.

In the first aspect, the air gap may have the shape corresponding to the irregular shape with a part of its circumference being recessed.

In the first aspect, the coil may be wound into a convex shape and post shaped in a fixture to reach the H shape, the S shape or any other concave shape.

A second aspect of the disclosure comprise a motor for a dynamic loudspeaker, comprising: pole plate; magnet positioned on the pole plate, comprising two outer magnets; magnet pole positioned on the magnet, comprising two outer poles and one inner pole; and coil positioned in the air gap formed between the two outer magnets as well as between the outer magnet poles and inner magnet pole, wherein the coil has a concave shape formed by recessing a part of its circumference in a plane view.

In the second aspect, the concave shape may be H shape or S shape.

In the second aspect, the concave shape may be irregular shape with a part of its circumference being recessed.

A third aspect of the disclosure comprises a motor for a dynamic loudspeaker, comprising: pole plate; an inner magnet positioned on the pole plate; magnet pole positioned on the magnet, comprising one inner pole and a plurality of outer poles; and coil positioned in the air gap formed between the outer magnet poles and inner magnet pole, wherein the coil has a concave shape formed by recessing a part of its circumference in a plane view.

In the third aspect, the concave shape may be H shape or S shape.

In the third aspect, the concave shape may be irregular shape with a part of its circumference being recessed.

A fourth aspect of the disclosure comprises a dynamic loudspeaker, comprising the motor according to any of the first, the second and the third aspect.

In the fourth aspect, the loudspeaker may further comprise a basket surrounding the pole plate, the magnet and the magnet pole.

In the fourth aspect, the loudspeaker may further comprise a front cover disposed on and butt jointed with the upper edge of the basket.

In the fourth aspect, the loudspeaker may further comprise a ring-shaped flexible suspension, the outer edge of which is fixed between the front cover and the basket.

In the fourth aspect, the loudspeaker may further comprise a piston plate positioned on the coil and attached at its circumference to the inner circumference of the flexible suspension.

In the fourth aspect, the loudspeaker may have a sensitivity of at least 0.5 dB, preferably at least 1.0 dB, and more preferably 2 dB higher than a loudspeaker equipped with a coil of convex shapes. The convex shapes may be rectangular, circular, ellipse shaped, racetrack shaped or any other convex shapes.

The material of the coil is not particularly limited, as long as it is suitable for use in a loudspeaker. The non-limiting examples of the coil comprise, for example, Cu (copper) and CCA (copper clattered aluminum), Al (Aluminum) etc. Other materials can also be used.

The fixture as used in the post-shaping may have, for example, moving parts and alternatively the adding of heat (hot air or process taking place inside an oven) during the post processing.

The aforementioned aspect of the disclosure accomplishes the following effects.

By adopting a coil having a concave shape, the coil in the motor has a prolonged length, which provides the dynamic loudspeaker according to the present disclosure with the advantages of increasing the sensitivity of the dynamic loudspeaker without raising the power level thereof This eliminates the need of increasing the working electrical current, and thus effectively avoids the disadvantages of heating up the coil caused by lowering the electrical impedance, which otherwise leads to a huge challenge in handling increased working temperature.

Furthermore, the dynamic loudspeaker according to the present disclosure provides the following secondary advantages due to the use of a concave-shaped coil instead of a conventional convex-shaped coil :
1) more surface area for gluing the coil to the piston plate, which potentially will allow for a thinner (lighter) piston maintaining the stiffness and thereby giving added sensitivity due to the lower weight;
2) more surface area for gluing of some magnets in 2 or more-magnet based magnet system increasing the drop test reliability; and
3) larger coil circumference, giving improved cooling effect and thereby lowering working temperature.

### BRIEF DESCRIPTION OF THE DRAWINGS

The features, advantages and technical and industrial significance of this disclosure will be described in the following detailed description of example embodiments of the disclosure with reference to the accompanying drawings, in which like numerals denote like elements, and wherein:

FIG. 1 is a cross-sectional view of an example of the motor according to the present disclosure;

FIG. 2 is a cross-sectional view of a magnet system for an H shaped coil according to the first embodiment of the present disclosure;

FIG. 3 is an exploded view of the loudspeaker having an H shaped coil according to the first embodiment of the present disclosure;

FIG. 4 is a schematic representation of the process for forming the H shaped coil according to the first embodiment and a comparison to a prior art rectangular coil taking up the same surface area in the loudspeaker;

FIG. 5 is a cross-sectional view of a magnet system for an S shaped coil according to the second embodiment of the present disclosure;

FIG. 6 is an exploded view of the motor having an S shaped coil according to the second embodiment of the present disclosure; and

FIG. 7 is a schematic representation of the process for forming the S shaped coil according to the second embodiment; and a comparison to a prior art rectangular coil taking up the same surface area in the loudspeaker basket.

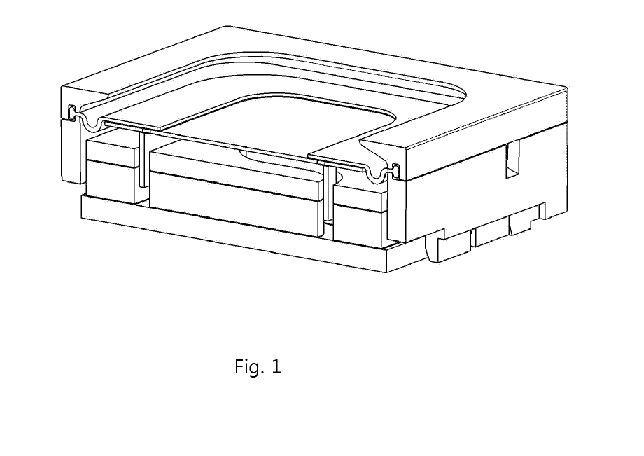

The exemplifications set out herein illustrate exemplary embodiments of the disclosure, and should not be construed as limiting the scope of the disclosure in any manner.

### DETAILED DESCRIPTION

Further detailed description of the present disclosure will be made below in combination with the drawings and embodiments, so that better understanding of the above object, features, and advantages of the present disclosure can be obtained. The embodiments disclosed herein are not intended to be exhaustive or to limit the present disclosure to the precise form disclosed in the following detailed description. Rather, the embodiments are chosen and described so that those skilled in the art may carry out their teachings.

The embodiments of the motors for use in dynamic loudspeakers are described in detail below.

### First Embodiment

The present embodiment provides a motor for a dynamic loudspeaker having an H shaped coil.

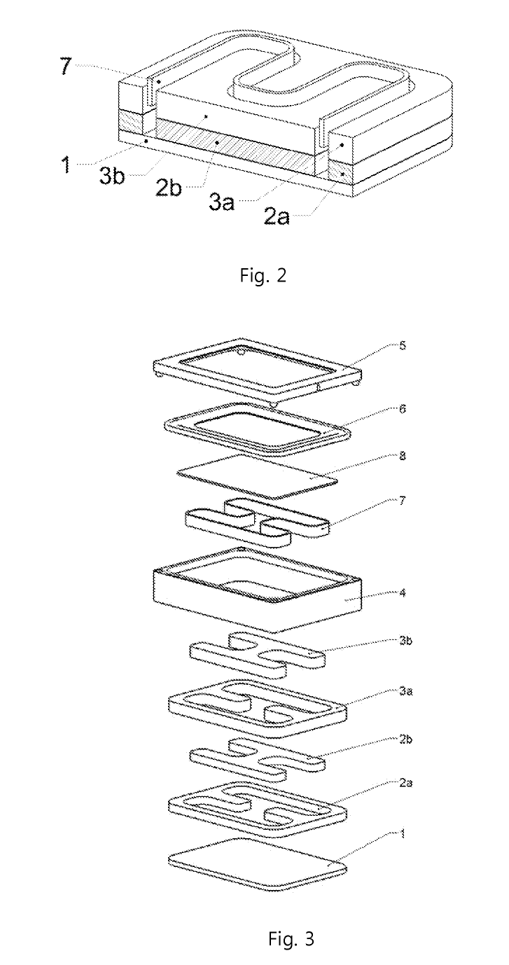

Embodiment 1 is described below in connection with FIGS. 2, 3 and 4. FIG. 2 is cross-sectional view of a magnet system for an H shaped coil according to the first embodiment of the present disclosure. FIG. 3 is an exploded view of a loudspeaker having an H shaped coil in an H shaped motor according to the first embodiment of the present disclosure.

Firstly, Referring to FIG. 3, a dynamic loudspeaker that comprises pole plate 1; magnet 2 positioned on the pole plate 1, comprising an outer magnet 2a and an inner magnet 2b; magnet pole 3 positioned on the magnet, comprising an outer pole 3a and an inner pole 3b; basket 4 surrounding the pole plate 1, the magnet 2 and the magnet pole 3; front cover 5 disposed on and butt jointedwith the upper edge of the basket; ring-shaped flexible suspension 6, the outer edge of which is fixed between the basket 4 and the front cover 5; coil 7 positioned in the air gap formed between the outer magnet 2a and the inner magnet 2b as well as between the outer magnet pole 3a and inner magnet pole 3b; and piston plate 8 positioned on the coil 7 and attached at its circumference to the inner circumference of the flexible suspension 6, wherein the coil 7 has an H shape.

The coil 7 is attached to the stiff piston plate 8 and the piston plate 8 is attached at its circumference to a flexible soft hinge/suspension 6, which allows the piston plate 8 to move up and down and thereby creating a sound pressure. The force to move the piston plate 8 up and down comes from the coil 7, which is positioned in a magnetic field in the air gap in the magnet system. This force is established when an electric current is running through the coil wire. This electrical current comes from an electronic amplifier delivering the signal (speech & music).

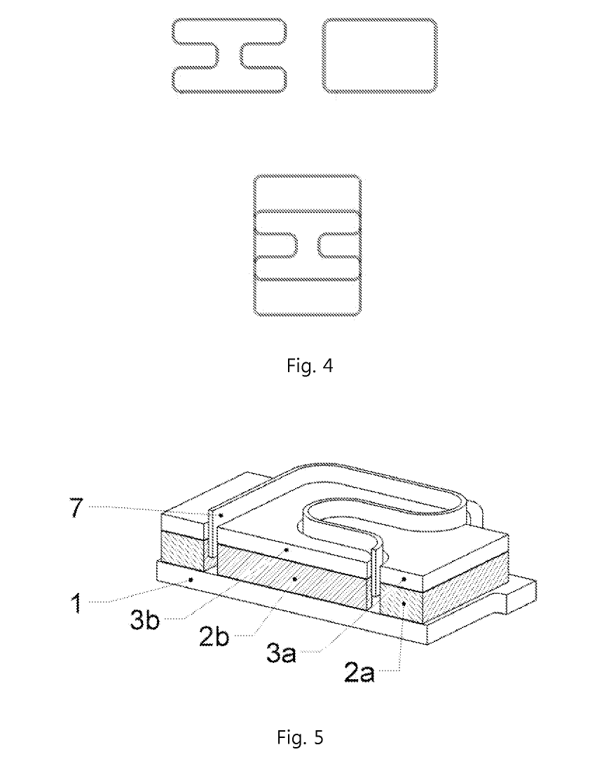

Referring to FIG. 4 now, a process for making an H shaped coil is schematically shown. The H coil can be formed by, for example, winding a rectangular coil, and then performing a post shaping in a fixture to obtain an H shape. The post shaping may comprise, for example, recessing the rectangular coil at a part of the circumference thereof The recessed part can be formed in the middle of the longer side of the rectangular coil. As an alternative, the recessed part can be formed in the middle of the shorter side of the rectangular coil, as shown in the lower part of FIG. 4.

Alternatively, the recessed part can be formed at other locations along the longer side or short side of the rectangular coil, as long as it has recessed shape. The recessed part may be formed as semi-rectangular shape as shown in FIG. 4, or alternatively, be formed with a hemi-spherical shape, or other regular or irregular shape.

In the first embodiment, a motor for use in a loudspeaker using an H shape coil is provided. Correspondingly, the effective length of the coil is increase by, for example at least 5%, preferably at least 10%, preferably at least 20%, preferably at least 30%, preferably at least 40%, preferably at least 50%, preferably at least 60%, preferably at least 70%, preferably at least 80%, preferably at least 90%, preferably at least 100%, preferably at least 200%, or even several times than the length of the initial rectangular coil, while not increasing the footprint of the motor. Therefore, the sensitivity of the loudspeaker can be significantly improved, without increasing the power level of the loudspeaker.

### Second Embodiment

The second embodiment, which is similar to the first embodiment, will be described below in connection with FIGS. 5, 6, and 7.

The magnet system provided in the second embodiment differs from the motor in the first embodiment in that it comprises an S shaped coil, as shown in FIG. 5.

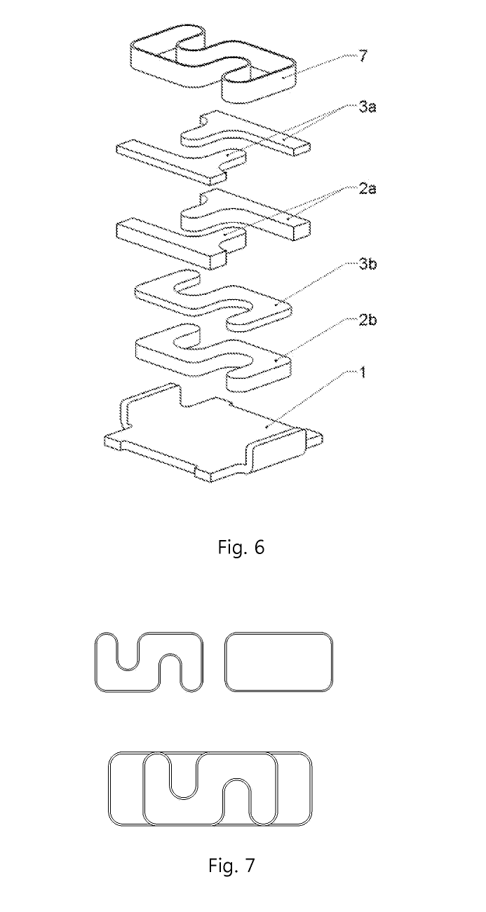

Referring to FIG. 6, the motor for a dynamic loudspeaker according to the second embodiment comprises pole plate 1; inner magnet 2b positioned on the pole plate 1, comprising two outer magnets 2a; magnet pole 3b positioned on the magnet, comprising outer poles 3a; coil 7 positioned in the air gap formed between the outer magnets 2a and the inner magnet 2b as well as between the outer magnet poles 3a and inner magnet pole 3b, wherein the coil 7 has an S shape.

Referring to FIG. 7 now, a process for making an S shaped coil is schematically shown. The S coil can be formed by, for example, winding a rectangular coil, and then performing a post shaping in a fixture to obtain an S shape. The post shaping may comprise, for example, recessing the rectangular coil at a part of the circumference thereof The recessed parts can be formed in the middle of the longer sides of the rectangular coil. As an alternative, the recessed part can be formed in the middle of the shorter sides of the rectangular coil.

Alternatively, the recessed parts can be formed at other locations along the longer side or short side of the rectangular coil, as long as it has recessed shape. The recessed parts may be formed as hemi-spherical shape as shown in FIG. 7, or alternatively, be formed with a rectangular shape, or other regular or irregular shape.

In the second embodiment, a motor for use in a loudspeaker using an S shape coil is provided. Correspondingly, the effective length of the coil is increase by, for example at least 5%, preferably at least 10%, preferably at least 20%, preferably at least 30%, preferably at least 40%, preferably at least 50%, preferably at least 60%, preferably at least 70%, preferably at least 80%, preferably at least 90%, preferably at least 100%, preferably at least 200%, or even several times than the length of the initial rectangular coil, while not increasing the footprint of the motor. Therefore, the sensitivity of the loudspeaker can be significantly improved, without increasing the power level of the loudspeaker.

Example Calculation on Gained Sensibility with Reference to Conventional Rectangular Coils Speaker

An example will be provided below for the purpose of demonstrating the effect of the present disclosure, rather than limiting the present disclosure thereto.

An S shaped copper coil was fabricated by first winding a wire into a convex shape, and then performing post-shaping in a fixture to reach an S shape.

The S shaped coil was in the dynamic loudspeaker fabricated as in the second embodiment. The sensitivity of the obtained loudspeaker was measured and calculated as follow.

### Magnet System Assumption/Calculations:

“Standard” 11×15×3.5 mm speaker with “push/pull” magnet system: B field in push/pull area: 0.72 T (simulated).

“S” shaped magnet system is assumed to have identical B field although the air gap path is longer. This is due to the larger outer magnets. Simulation needs to be made for verification.

### Coil Calculation:

Increased sensitivity due to larger “I”: 42.5 mm/31.4 mm=1.354 gg [symbol] 2.63 dB.

Moving Mass Calculations:

Change in sensitivity due to change in moving mass:

“Normal” Speaker moving mass:
Coil: 21 mg
Piston: 20 mg
Silicone hinge, glue etc.: 26 mg
Total: 67 mg

“S” shaped coil speaker moving mass:
Coil: 28.4 mg
Piston: 15 mg
Silicone hinge, glue etc.: 26 mg
Total: 69.4 mg

Loss in sensitivity: 67 mg/69.4 mg=0.965 [symbol] −0.3 dB

Net gained sensitivity: 2.63 dB−0.3 dB=2.33 dB.

It can be seen that, about 2 dB increase in sensitivity of the dynamic loudspeaker over the dynamic loudspeaker that uses conventional rectangular coil can be achieved by adopting the S shaped coil as disclosed in the present disclosure.

All examples and conditional language recited herein are intended for pedagogical purposes to aid the reader in understanding the disclosure and the concepts contributed by the inventor to furthering the art, and are to be construed as being without limitation to such specifically recited examples and conditions, nor does the organization of such examples in the specification relate to a showing of the superiority and inferiority of the disclosure. Although the embodiments of the present disclosure have been described in detail, it should be understood that the various changes, substitutions, and alterations could be made hereto without departing from the spirit and scope of the disclosure.

1. A motor for a dynamic loudspeaker, comprising:
a pole plate;
a plurality of magnets positioned on the pole plate, comprising a plurality of outer magnets and an inner magnet;
a plurality of magnet poles positioned on the magnets, comprising a plurality of outer magnet poles and an inner magnet pole;
and a coil positioned in air gap formed between the outer magnets and the inner magnet as well as between the outer magnet poles and the inner magnet pole,
wherein the coil has a concave shape formed by recessing a part of its circumference in a plane view.

2. The motor according to claim 1, wherein the concave shape is an H shape or an S shape.

3. The motor according to claim 1, wherein the concave shape has an irregular shape with a part of its circumference being recessed.

4. The motor according to claim 2, wherein the air gap formed between the outer magnets and the inner magnet is an H shape or an S shape.

5. The motor according to claim 2, wherein the air gap formed between the outer magnet poles and the inner magnet pole is an H shape or an S shape.

6. The motor according to claim 3, wherein the air gap has a shape corresponding to the irregular shape with a part of its circumference being recessed.

7. The motor according to claim 2, wherein the coil is wound into a convex shape and post shaped in a fixture to reach the H shape, the S shape, or any other concave shapes with a part of its circumference being recessed.

8. A motor for a dynamic loudspeaker, comprising:
a pole plate;
a plurality of magnets positioned on the pole plate, comprising two outer magnets;
a plurality of magnet poles positioned on the magnets, comprising two outer magnet poles and one inner magnet pole;
and a coil positioned in an air gap formed between the two outer magnets as well as between the outer magnet poles and the inner magnet pole,
wherein the coil has a concave shape formed by recessing a part of its circumference in a plane view.

9. The motor according to claim 8, wherein the concave shape is an H shape or an S shape.

10. The motor according to claim 8, wherein the concave shape has an irregular shape with a part of its circumference being recessed.

11. A motor for a dynamic loudspeaker, comprising:
a pole plate;
an inner magnet positioned on the pole plate;
a magnet pole positioned on the inner magnet, comprising one inner magnet pole and a plurality of outer magnet poles;
and a coil positioned in the-an air gap formed between the outer magnet poles and the inner magnet pole,
wherein the coil has a concave shape formed by recessing a part of its circumference in a plane view.

12. The motor according to claim 11, wherein the concave shape is an H shape or an S shape.

13. The motor according to claim 11, wherein the concave shape has an irregular shape with a part of its circumference being recessed.

14. A dynamic loudspeaker having a motor, the motor comprising:
a pole plate;
one or more magnets positioned on the pole plate;
one or more magnet poles positioned on the one or more magnets; and
a coil positioned in an air gap;
wherein a configuration of the one or more magnets, the one or more magnet poles, and the air gap is one of:
the one or more magnets including a plurality of outer magnets and an inner magnet, the one or more magnet poles having a plurality of outer magnet poles and an inner magnet pole, and the air gap being formed between the plurality of outer magnets and the inner magnet as well as between the plurality of outer magnet poles and the inner magnet pole;
the one or more magnets including two outer magnets, the one or more magnet poles having two outer magnet poles and one inner magnet pole, and the air gap being formed between the two outer magnets as well as between the outer magnet poles and the inner magnet pole; and
the one or more magnets including an inner magnet, the one or more magnet poles having one inner magnet pole and a plurality of outer magnet poles, and the air gap being formed between the plurality of outer magnet poles and the inner magnet pole;
and wherein the coil has a concave shape formed by recessing a part of its circumference in a plain view.

15. The dynamic loudspeaker according to claim 14, further comprising a basket surrounding the pole plate, the one or more magnets and the one or more magnet poles.

16. The dynamic loudspeaker according to claim 15, further comprising a front cover disposed on and butt-jointed with an upper edge of the basket.

17. The dynamic loudspeaker according to claim 16, further comprising a flexible suspension, an outer edge of which is fixed between the front cover and the basket.

18. The dynamic loudspeaker according to claim 17, further comprising a piston plate positioned on the coil and attached at its circumference to an inner circumference of the flexible suspension.

19. The dynamic loudspeaker according to claim 14, wherein the loudspeaker has a sensitivity of at least 0.5 dB higher than a loudspeaker equipped with convex-shaped coil.

20. The loudspeaker according to 19, wherein the loudspeaker has a sensitivity of at least 1 dB higher than a loudspeaker equipped with convex-shaped coil.

21. The loudspeaker according to 20, wherein the loudspeaker has a sensitivity of at least 2 dB higher than a loudspeaker equipped with convex-shaped coil.

22. The dynamic loudspeaker according to claim 14, wherein the concave shape is an H shape or an S shape.

23. The dynamic loudspeaker according to claim 14, wherein the concave shape is an irregular shape with a part of its circumference being recessed.

24. The dynamic loudspeaker according to claim 23, wherein the air gap has a shape corresponding to the irregular shape with a part of its circumference being recessed.

25. The dynamic loudspeaker according to claim 22, wherein the coil is wound into a convex shape and post shaped in a fixture to reach the H shape, the S shape, or any other concave shape with a part of its circumference being recessed.
